(19) United States
(12) Patent Application Publication
(10) Pub. No.: US 2009/0051702 A1
(43) Pub. Date: Feb. 26, 2009

(54) PROCESS AND APPARATUS FOR GENERATING MAP DATA IN REAL TIME

(75) Inventors: Joao Morbey, Toulouse (FR); Mathieu Landman, Toulouse (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Airbus France, Toulouse (FR)

(21) Appl. No.: 12/191,009

(22) Filed: Aug. 13, 2008

(30) Foreign Application Priority Data
Aug. 21, 2007 (FR) 0757120

(51) Int. Cl. G09G 5/00

(52) U.S. Cl. 345/629

(57) ABSTRACT

The invention has in particular as an object the generation, in real time, of a background map on the basis of a plurality of electronic maps having different projection parameters and geodesic parameters. After at least two electronic maps have been selected (300, 800), at least part of these maps is converted (315) according to projection parameters and geodesic parameters predetermined as a function of projection parameters and geodesic parameters associated with each of these selected electronic maps. A background map is then constructed (325) on the basis of these converted electronic maps.

The present invention relates to the field of cartography and more particularly to methods and devices for generating, in real time, background maps adapted in particular to navigation aid devices for vehicles.

In numerous technical fields, the development of digital processing tools and of man-machine interfaces, also known as MMI, has the purpose in particular of reducing the volume of paper documents in favor of electronic documents. Such an objective is aimed on the one hand at reducing costs such as usage and storage costs and on the other hand at increasing the ease of use and the capabilities offered by the flexibility of electronic documents, such as updating and storage in memory of modifications.

The field of cartography is following this evolution. Thus it is now common to find a guide application based on electronic cartography in a mobile telephone.

Two formats typically exist for electronically representing a map. A first format corresponds to a paper photograph of the maps, moreover it often relates to paper maps that have been digitized. According to this format, the electronic map can be considered as an image or as a matrix whose abscissas and ordinates represent geographic coordinates, in latitude and longitude, for example, and whose value represents a color, or in other words an information item about the nature of the point, such as a topological indication. The indications given by the map, such as a place name, are represented in the same way, by a set of color points. Electronic maps using this format are generally known as raster maps in English terminology.

According to a second format, a description of the map is used to generate the map or a part of the map when such is used. Such a description comprises a geometric description of elements of the map. Thus, in contrast to the first format, a highway is characterized not by a set of points of the same color but by a set of geometric elements such as vectors and arcs of circles. The indications given by the map are also represented in descriptive form, for example in the form of lists comprising pairs of geographic position and character strings. The electronic maps using this format are generally known as vector maps.

An advantage of vector maps over raster maps lies in the density of information items that can be stored in memory, or in other words in the number of information items that can be stored in memory for a given storage capacity, as well as in the simplicity of certain processing operations, such as the choice of density of viewed information items.

The raster maps are generally obtained directly from existing paper maps. They are determined for a given scale. For example, 1:50,000 and 1:250,000 maps exist. The choice of scale is determined by the density of desired information items.

This type of map is used in particular in certain vehicles such as aircraft.

Furthermore, the raster maps are recorded with a precision defined during digitization. Thus it is possible to determine the resolution of each map point, also known as pixel (acronym for Picture Element in English terminology), or in other words the length represented by this point. The resolution of a pixel is the ratio of the map scale to the resolution of the digitization. When a raster map is displayed on a screen, it is possible to change the viewing scale by using standard image-processing functions such as interpolation.

In general, a map represents a limited area of the earth. The management of maps or map elements is often optimized by a hierarchical organization making it possible to rapidly retrieve maps or certain of their elements representing neighboring areas.

Furthermore, navigation aid devices for vehicles such as aircraft are generally centralized devices adapted to select the map to be displayed, typically a map of raster type, and to determine the display resolution and the position of the map relative to the screen. The selected map may be displayed in real time on a navigation screen, thus forming a background map on which supplementary information items can be displayed by superposition. Such supplementary information items are, for example, tactical information items, traffic information items and/or navigation information items. All calculations necessary for addition of these information items are often performed in the navigation aid devices. Typically, the center and orientation of the background map are determined by the position and direction of the vehicle.

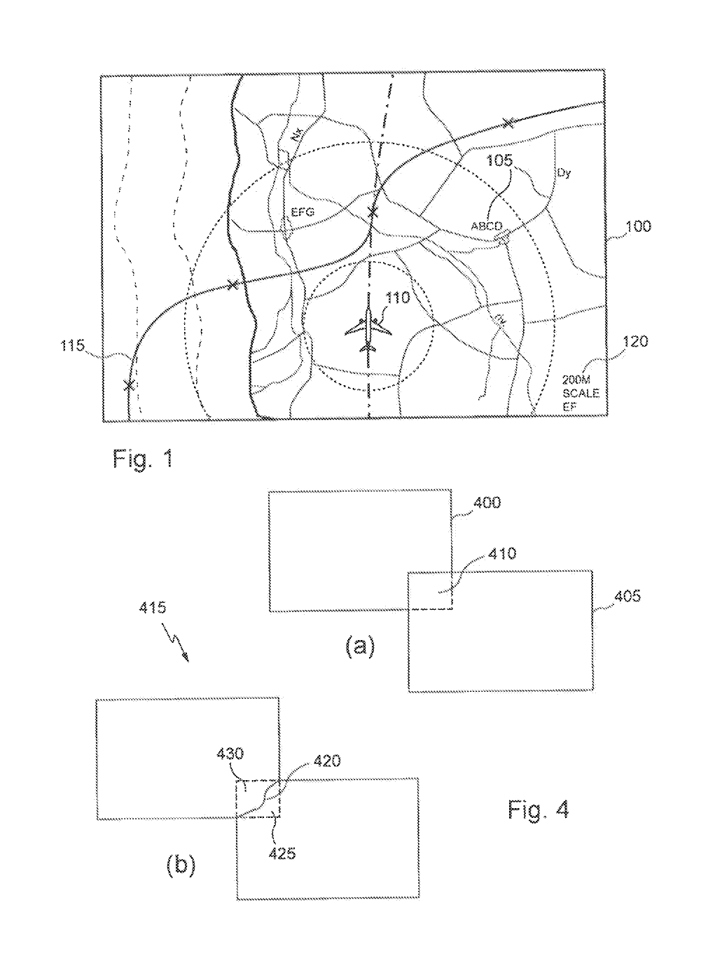

FIG. 1 illustrates an example of a background map and of supplementary information items displayed on a navigation aid device. As shown, a screen 100 displays a background map comprising cartographic information items 105 such as highways, relief features and waterways, with indications such as place names. In this case, screen 100 also indicates the position 110 of the aircraft using this navigation aid device as well as its direction and distance curves (as broken lines). Other information items such as a highway 115 and display parameters 120 are also displayed.

When the position of the vehicle does not belong to the map selected to form the displayed background map, a new map is selected in order to construct a new background map.

The invention makes it possible to overcome at least one of the problems mentioned in the foregoing.

The invention therefore has as an object a method for constructing at least one background map in real time on the basis of a plurality of electronic maps, projection parameters and geodesic parameters being associated with each of the said electronic maps, this method comprising the following steps,

selection of at least two electronic maps among the said plurality of electronic maps;
conversion of at least part of the said at least two selected electronic maps according to projection parameters and geodesic parameters predetermined as a function of projection parameters and geodesic parameters associated with each of the said at least two selected electronic maps; and

construction of a background map on the basis of the said at least two converted electronic maps.

The method according to the invention thus makes it possible to construct a background map, preferably in real time, on the basis of a plurality of electronic maps, the projection parameters and/or the geodesic parameters of the electronic maps being able to be different.

According to a particular embodiment, the method additionally comprises a step of adaptation of resolution of at least part of one of the said at least two selected electronic maps in order to construct a background map on the basis of a plurality of electronic maps having different resolutions.

Advantageously, the said conversion step comprises a step of orthographic azimuthal projection of at least part of the said at least two selected electronic maps. Orthographic azimuthal projection makes it possible in particular to obtain a unique cartographic representation, independent of the parameters of the electronic maps.

Each of the said at least two converted electronic maps is preferably represented on a separate graphic layer in order to simplify construction of the background map on the basis of electronic maps and possibly other data. The use of separate graphic layers also makes it possible to simplify the management of zones of coverage of electronic maps as well as the management of the display of supplementary information items.

According to a particular embodiment, the said conversion step comprises the following steps,

projection of at least part of the said at least two selected electronic maps onto a sphere according to the projection parameters and the geodesic parameters associated with the said at least two selected electronic maps, referred to as first projection; and

projection, onto a plane, of at least part of the said projection of at least part of the said at least two selected electronic maps onto a sphere, referred to as second projection.

The method according to the invention can therefore be implemented simply and effectively by existing devices that offer the necessary graphical functions, such as a graphic processor.

Advantageously, the said second projection is an orthographic azimuthal projection.

A priority level is preferably assigned to each of the said at least two selected electronic maps in order to favor one electronic map relative to another according to, for example, its parameters.

According to a particular embodiment, the method further comprises a step of addition of at least one geo-localized datum in order to enrich the constructed background map.

The invention also has as an object a computer program comprising instructions adapted to the implementation of each of the steps of the method described in the foregoing as well as a device comprising means adapted to implementation of each of the steps of the method described in the foregoing.

Other advantages, objectives and characteristics of the present invention will become evident from the following detailed description, written by way of non-limitative example with reference to the attached drawings, wherein:

FIG. 1 illustrates an example of a background map and of supplementary information items displayed on a navigation aid device;

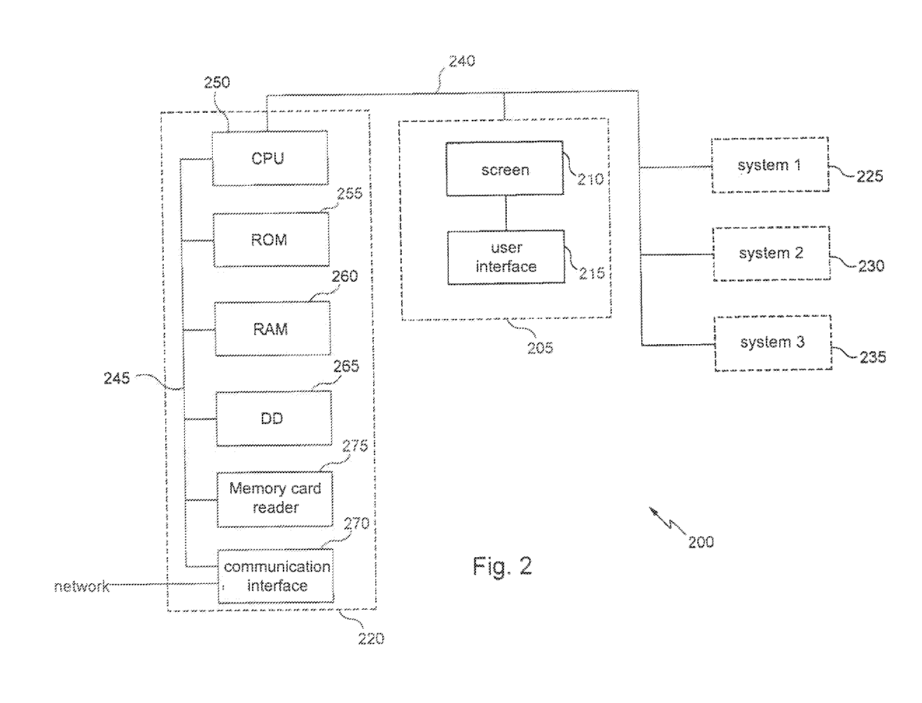

FIG. 2 illustrates an example of a navigation aid device adapted to implement the invention;

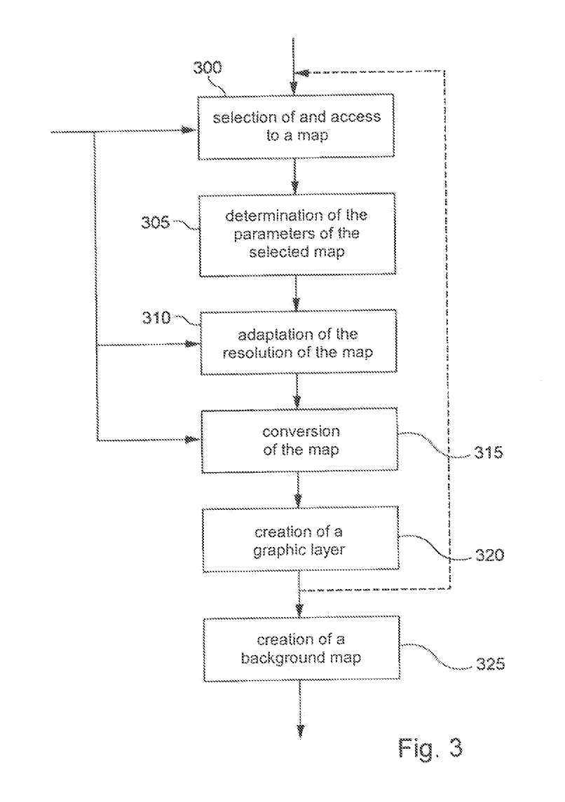

FIG. 3 illustrates certain steps of the method of the invention for determining, in real time, a background map on the basis of a plurality of electronic maps;

FIG. 4, comprising FIGS. 4a and 4b, illustrates examples of management of coverage of electronic maps by the use of priority and by preliminary assembly respectively;

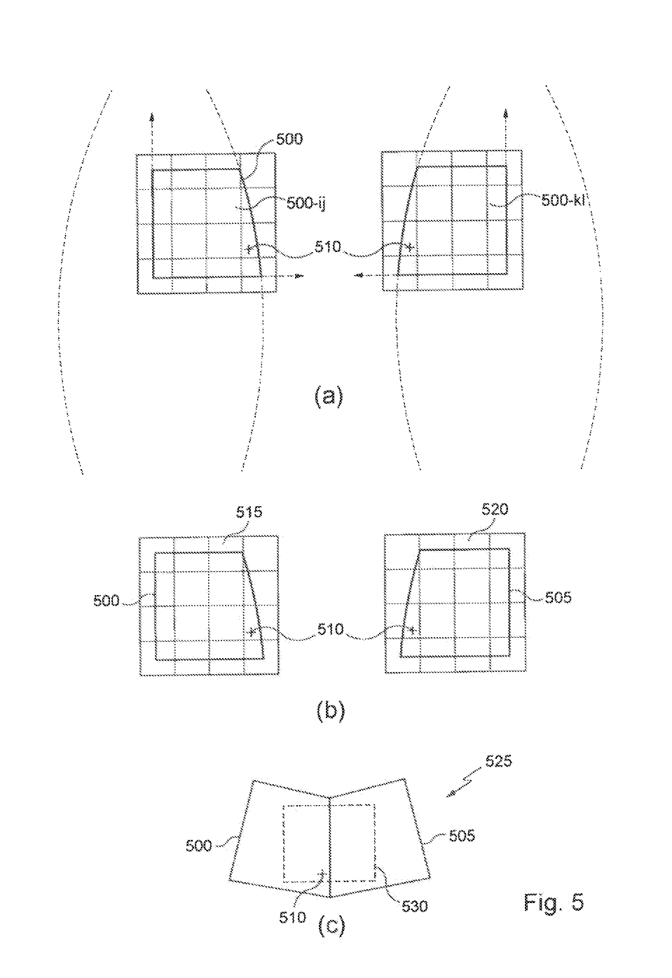

FIG. 5, comprising FIGS. 5a, 5b and 5c, schematically represents the result of certain steps of the method for constructing a background map presented in FIG. 3;

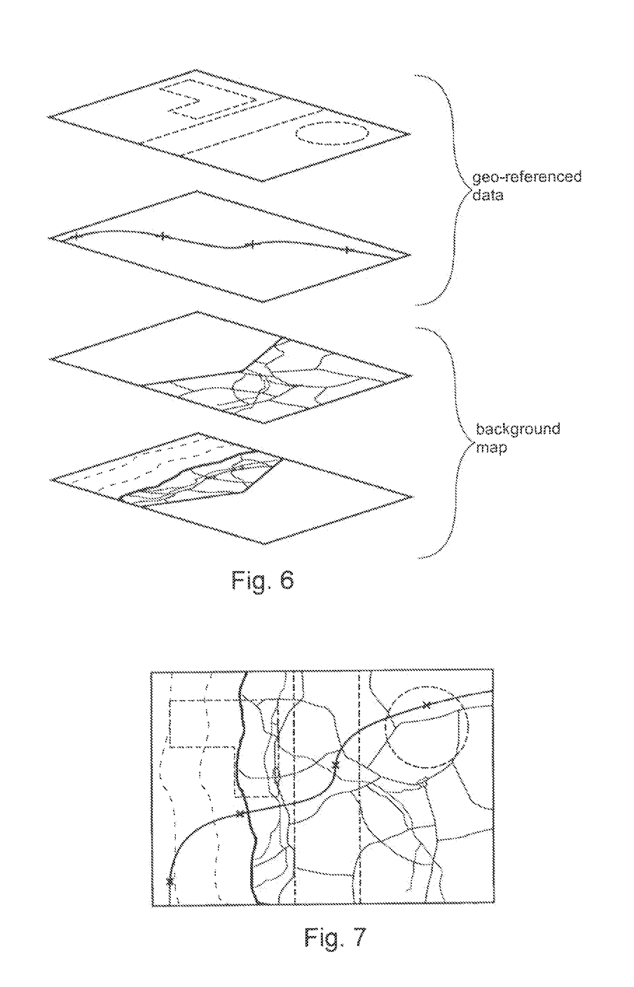

FIG. 6 illustrates an example of the display of navigation information items composed of a background map and of geo-referenced data;

FIG. 7 represents the display of the graphic layers illustrated in FIG. 6;

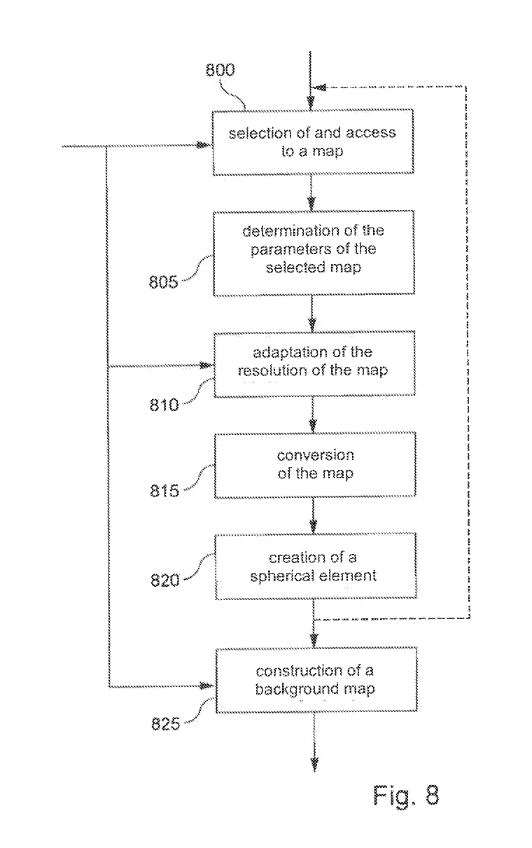

FIG. 8 illustrates certain steps of the method of the invention for determining, in real time, a background map on the basis of a plurality of electronic maps according to a second embodiment; and

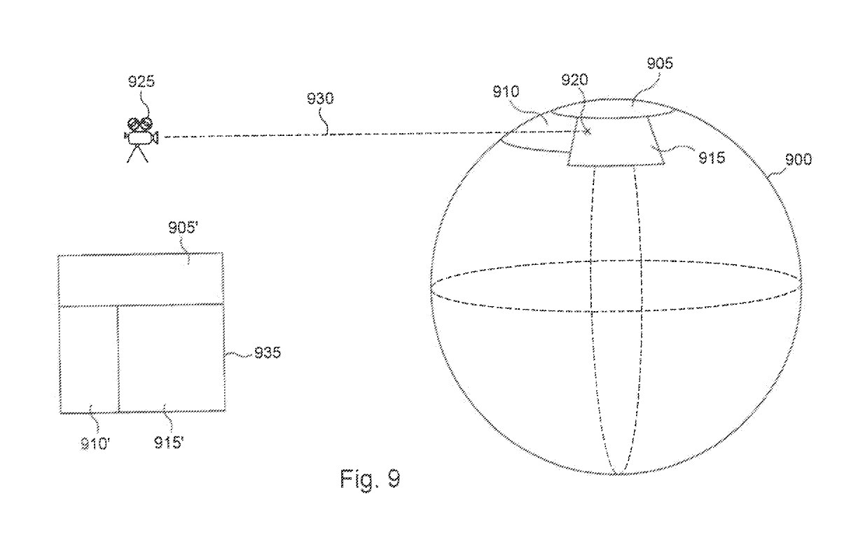

FIG. 9 illustrates an example of implementation of the method described with reference to FIG. 8.

The invention permits simultaneous display of several electronic maps on the same screen in such a way that a navigation aid device is capable of constructing and displaying, in real time, a complete background map around a determined point according to a determined display coverage. Such a background map can be used in particular to display, in real time, geo-referenced information items such as tactical information items, navigation information items and/or traffic information items.

The invention is advantageously implemented according to a decentralized mode, or in other words the device for construction of the background map is independent of the display device and of the devices for storage or determination of the geo-referenced information items to be displayed.

It is appropriate initially to recall that, because of the complex shape of the earth, it is not possible faithfully to transpose geographic data of the earth into a planar cartographic representation. It is therefore necessary to determine a cartographic projection in order to transpose geographic data related to the earth's surface into a planar cartographic representation. In simplified manner, the cartographic projection is defined relative to an ellipsoid representing the earth as well as by positioning parameters of this ellipsoid that are known as the geodesic datum.

There exist several types of cartographic projections, including the equivalent projection, which locally conserves areas, the conformal projection, which locally conserves the angles (and therefore the shapes) and the aphylactic projection, which is neither conformal nor equivalent but can be equidistant, or in other words can conserve the distances along the meridians.

From a mathematical viewpoint, the cartographic projections can be classified into three families: the cylindric projections, the conic projections and the azimuthal projections.

According to the cylindric projection, the ellipsoid is projected onto a cylinder that includes it, this cylinder being able to be tangential to a circle such as the equator or secantial in two circles such as lines of latitude or any other circle formed by the intersection of the ellipsoid with a plane. After projection, the cylinder is developed to obtain a map. Depending on the type of cylindric projection, the projection may be equivalent, conformal or aphylactic. Similarly, in a conic projection, the ellipsoid is projected onto a cone.

According to the azimuthal projection, the ellipsoid is projected onto a plane, such as a plane tangential to one point of the ellipsoid. Depending on the position of the perspective point used for the projection, the projection may be stereographic, gnomonic or orthographic. In an orthographic azimuthal projection, the perspective point is at infinite distance. The areas and shapes are then deformed, but the distances are preserved along the lines of latitude. Furthermore, depending on the position of the tangent plane, the azimuthal projection is said to be polar (tangent plane at a pole), equatorial (tangent plane at a point of the equator) or oblique (tangent plane at another point).

The methods and devices according to the invention are adapted to combine a plurality of electronic maps having different characteristics, particularly as regards their projection system, the geodesic datum used, their resolution, the hierarchical organization of map elements and the type of data compression that possibly may be used to store these maps.

FIG. 2 illustrates an example of navigation aid device 200 adapted to implement the invention. As shown, device 200 is provided with a device 205, itself comprising a display device 210 and a user interface 215. The display device is preferably a screen such as a TFT LCD screen (initials for Thin-Film Transistor and Liquid Crystal Display respectively in English terminology). Alternatively, the display device can be a heads-up viewing system. User interface 215 may be independent of the display device, for example a keyboard and/or a mouse, or integrated in the display device, for example in the form of a touch screen. The user interface can be used in particular to enter a reference point of the map to be displayed, such as the center thereof or a particular position, such as the position of the vehicle on the display device, as well as the display coverage, or in other words the geographic zone of the earth covered by the background map.

Navigation aid device 200 is also provided with a processing device 220 according to the invention, in order to construct a background map in real time, a device 225 for management of navigation information items, a device 230 for management of traffic information items and a device 235 for management of tactical information items. Devices 225 to 235 are not necessary to the implementation of the invention. Some of these devices may be implemented and others not. It is also possible to add other similar systems for furnishing geo-referenced information items to display device 210, in order that these information items will be superposed on the background map. The geo-referenced information items can be displayed systematically or displayed at the user's request.

Devices 220 to 235 are connected to device 205 by a communication bus 240, for example a connection of Ethernet type such as AFDX. Devices 220 to 235 are therefore capable of receiving, from user interface 215 or from another device, a reference point and a coverage permitting them to construct the graphical background and to determine the position of geo-referenced information items to be displayed. For example, the reference point is the position, expressed in latitude and longitude, of the aircraft on board which such a navigation aid device is installed. The coverage is, for example, the distance in nautical miles between the extreme points of the display device. The reference point preferably corresponds to a fixed point of the display device, such as the point situated at the intersection of the vertical median of the display device and the line bounding the lower horizontal quarters of the display device, as represented in FIG. 1.

Processing device 220 is provided with a communication bus 245, to which there are connected:
a central processing unit or microprocessor 250 (CPU, Central Processing Unit);
a non-volatile memory 255 (ROM, Read Only Memory), which may contain programs for processing electronic maps, and
a volatile memory or cache memory 260 (RAM, Random Access Memory), containing registers adapted to record the variables and parameters, such as cartographic data, created and modified during execution of the aforesaid programs.

As an option, processing device 220 may also be provided with:
a hard disk 265, which can contain the aforesaid programs, processed data or data to be processed according to the invention, as well as electronic maps;
a communication interface 270 connected to a distributed communication network, such as the AFDX network, different from that represented by communication bus 240, the interface being able to transmit and receive data; and
a memory card reader 275 adapted to read or write therein processed data or data to be processed according to the invention as well as electronic maps.

The communication bus permits communication and interoperability between the different elements included in processing device 220 or connected thereto. The representation of the bus is not limitative and, in particular, the central unit is capable of communicating instructions to any element of processing device 220 directly or by way of another element of processing device 220.

The executable code of each program permitting the programmable apparatus to implement the processes according to the invention may be stored, for example, in hard disk 265 or in read-only memory 255.

According to a variant, the executable code of the programs will be capable of being received by way of the communication network, via interface 270, so as to be stored in a manner identical to that described in the foregoing.

The memory cards may be replaced by any information medium such as, for example, a compact disk (CD ROM). In general, the memory cards can be replaced by information storage means that can be read by a computer or by a microprocessor, which means may or may not be integrated with the apparatus and may be removable, and adapted to store in memory one or more programs whose execution permits implementation of the method according to the invention as well as the electronic maps for forming the background map.

More generally, it will be possible to load the program or programs into one of the storage means of processing device 220 before executing them.

Central unit 250 will command and direct the execution of instructions or portions of software code of the program or programs according to the invention, such instructions being stored in hard disk 265 or in read-only memory 255 or else in the other aforesaid storage elements. When the power is turned on, the program or programs stored in a non-volatile memory, such as hard disk 265 or read-only memory 255, are transferred into random-access memory 260, which then contains the executable code of the program or programs according to the invention as well as the registers for storage in memory of the variables and parameters necessary for implementation of the invention.

It should be noted that the communication apparatus provided with processing device 220 may also be a programmed apparatus. This apparatus then contains the code of the information-processing program or programs, which code is fixed, for example, in an application-specific integrated circuit (ASIC).

According to a particular embodiment, CPU 250 is a standard graphic processor capable in particular of managing images by graphic layers, according to an overlay principle, of managing texturizing functions for applying a surface (texture) to a three-dimensional object and of managing a virtual camera function capable of projecting a three-dimensional object onto a plane surface according to a determined point and projection plane.

FIG. 3 illustrates certain steps of the method of the invention for determining, in real time, a background map on the basis of a plurality of electronic maps according to a first embodiment.

A step 300 has as its object the selection of one or more electronic maps according to a reference point and a coverage received from the user interface or from another device. On the basis of this reference point and this coverage, the system determines the geographic zone to be displayed and deduces therefrom the electronic maps necessary for construction of the background map. This selection function is based on a standard hierarchical organization determined according to the geographic coverage of the maps, their resolution and possibly other parameters, such as their scale.

The choice of electronic maps is determined in particular by the required coverage. Knowing the number of points per line and per column of the display device, it is possible, by means of the required coverage, to deduce therefrom the required display resolution and to compare it with that of the map. Preferably the choice of the map (and therefore of the resolution of the map) is such that the resolution of the map is greater than or equal to the required display resolution.

When the electronic map or maps have been selected, they are accessed, meaning, for example, that they are copied into the working memory of the device for processing the electronic maps. According to the illustrated example of configuration of the processing device, the electronic maps are accessed in a memory card, in a hard disk or via a network on a remote server. Depending on their storage format, the maps are decompressed if necessary, so that they can be utilized directly in a standard format, for example a rough representation of the image such as the bitmap format. If necessary, the map elements are organized hierarchically according to a predetermined standard format.

In a subsequent step, the parameters of the selected electronic maps are determined (step 305).

Thereafter, if the resolution of the electronic maps is different from the required display resolution, the selected electronic maps are adapted as a function of their resolution so as to conform with the required display resolution (step 310). If the resolution of the electronic maps is greater than the required display resolution, this step consists in reducing the size of the image representing the map, for example by suppression of points or by weighting. Conversely, if the resolution of the electronic maps is poorer than the required display resolution, this step consists in increasing the size of the image representing the map, for example by interpolation of points on the basis of image points.

The maps are then converted so as to conform with a predetermined geodesic datum and cartographic projection (step 315). Preferably the maps are converted so as to conform with the WGS84 system and with an orthographic azimuthal projection according to a plane tangential to the earth at the point determined by the position of the vehicle on board which the navigation aid device is installed and according to a projection point located at infinity. Such a transformation is defined mathematically by the characteristics of the geodesic datum and of the cartographic projection of the map as well as by the characteristics of the predetermined geodesic datum and cartographic projection, which in this case are the WGS84 system and the orthographic azimuthal projection.

In a subsequent step (step 320), a graphic layer is created for each converted electronic map.

These graphic layers are then superposed, according to a predetermined priority, to form the background map (step 325).

Although, according to the foregoing description, all the electronic maps necessary for construction of a background map are processed simultaneously, in parallel manner, it is possible to process these electronic maps in sequential manner, as illustrated by the dashed arrow.

Advantageously, a priority is assigned to each electronic map used to construct a background map in order to manage the coverage of the electronic maps. By way of illustration, the priority can be determined during the step of selection of electronic maps according to their resolution, the priority being assigned according to their resolution (the priority becomes higher with increasing resolution), according to the distance between the reference point used and the closest point of the map, or according to the source of the map (a French user will prefer to use a French map rather than a Spanish map and vice versa).

During construction of the background map, the graphic layers are superposed one upon another, in such a way that the graphic layer corresponding to the electronic map having the highest priority is on top and masks the common parts, or in other words the parts containing cartographic information items of lower graphic layers. The parts of graphic layers that do not contain any cartographic information item have no texture in this case, or in other words are transparent.

The management of the graphic layers is preferably effected by a graphical processor offering such functionality.

Alternatively, the electronic maps can be assembled before being used, so as to suppress all the coverage zones.

FIG. 4, comprising FIGS. 4a and 4b, illustrates examples of management of coverage of electronic maps by the use of priority and by preliminary assembly respectively.

FIG. 4 illustrates the construction of a background map on the basis of two maps 400 and 405 forming two graphic layers. According to this example, priority levels are associated with maps 400 and 405. In this case the priority level of map 405 is higher than that of map 400. Thus the graphic layer associated with map 405 is placed above that associated with map 400. Consequently, zone 410 of coverage of the maps is represented by a portion of map 405, the corresponding portion of map 400 being masked by map 405.

FIG. 4b illustrates the assembly of two electronic maps before the construction of a background map. According to this example, two maps 400′ and 405′ are assembled to form a single electronic map 415 that can be used by the navigation aid device. During assembly of these maps, a boundary 420 is determined for each coverage zone, in order to determine which map is used. This boundary can be defined manually or automatically according to criteria such as the resolution of the maps or the information items contained in the maps. In this example, zone 425 is obtained from map 405′ while zone 430 is obtained from map 400′. Neither zone 425 of map 400′ nor zone 430 of map 405′ is used to form map 415.

It should be noted here that preliminary assembly of electronic maps makes it possible to suppress redundant information items and thus to economize on the memory space necessary for storage of electronic maps. Naturally, the assembled maps must be defined according to the same parameters, especially according to the same projection and the same resolution.

FIG. 5, comprising FIGS. 5a, 5b and 5c, schematically represents the result of certain steps of the method for constructing a background map presented in FIG. 3.

FIG. 5a illustrates the step of selection of two electronic maps 500 and 505 according to the position of a reference point 510. In this case, each map is composed of a set of map elements having generic references 500-ij and 505kl respectively. The dashed curves schematically illustrate meridians.

When electronic maps 500 and 505 are selected, the processing device loads them into working memory, decompressing them if necessary, and organizes the map elements hierarchically according to a predetermined standard scheme.

Zones 515 and 520 of maps 500 and 505 (FIG. 5b), which do not comprise any cartographic information item, are identified in such a way that these zones are transparent when they are displayed.

Electronic maps 500 and 505 are then converted to be represented according to common parameters, as described in the foregoing, in order to construct a background map 525 as illustrated in FIG. 5c. Part 530 of background map 525, comprising reference point 510 and corresponding to the dimensions of the display device, is then displayed.

As indicated in the foregoing, it is possible to add geo-referenced data to the background map. Such data are preferably positioned in one or more graphic layers separate from the graphic layers used to form the background map, these layers being displayed in a manner superposed on the background map. The positioning of the geo-referenced data is determined by the reference point and the display coverage, independently of the construction of the background map.

FIG. 6 illustrates an example of display of a navigation information item composed of a background map and of geo-referenced data. As illustrated, the background map is composed of a plurality of graphic layers (the number of graphic layers in this case being determined by the number of electronic maps used to construct the background map). Similarly, geo-referenced data are represented according to a plurality of graphic layers. For example, one graphic layer can be used to display tactical data, another graphic layer can be used to display navigation data and another graphic layer can be used to display traffic data. This display mode makes it easy to select which are the data that must be displayed by addition or suppression of graphic layers. In addition, this display mode makes it possible to define the priority of the data to be displayed in order of superposition of the graphic layers.

FIG. 7 represents the display of the graphic layers illustrated in FIG. 6.

According to a second embodiment, the electronic maps used to construct a background map are projected onto a sphere, the background map then being determined by an orthographic azimuthal projection onto the plane tangential to the sphere at the reference point according to a projection point located at infinity. When it is implemented by means of a graphic processor, this embodiment makes it possible to benefit from the functions of the graphic processor, especially the function of texturization of three-dimensional objects (projection of a map onto a sphere) and the virtual camera function (orthographic azimuthal projection).

FIG. 8 illustrates certain steps of the method of the invention for determining, in real time, a background map on the basis of a plurality of electronic maps according to a second embodiment.

A step 800, similar to step 300 described in the foregoing, has as its object the selection of one or more electronic maps according to a reference point and a coverage received from the user interface or from another device. On the basis of this reference point and of the coverage, the system determines the geographic zone to be displayed and deduces therefrom the electronic maps necessary for construction of the background map. This selection function is based on a standard hierarchical organization determined in particular according to the geographic coverage of the maps and their resolution.

As described in the foregoing, the choice of electronic maps is determined in particular by the required coverage. Knowing the number of points per line and per column of the display device, it is possible, by means of the required coverage, to deduce therefrom the required display resolution and to compare it with that of the map. Preferably the choice of the map (and therefore of the resolution of the map) is such that the resolution of the map is greater than or equal to the required display resolution.

When the electronic map or maps have been selected, they are accessed, meaning, for example, that they are copied into the working memory of the device for processing the electronic maps. According to the illustrated example of configuration of the processing device, the electronic maps are accessed in a memory card, in a hard disk or via a network on a remote server. Depending on their storage format, the maps are decompressed if necessary, so that they can be utilized directly in a standard format, for example a rough representation of the image such as the bitmap format. If necessary, the map elements are organized hierarchically according to a predetermined standard format.

In a subsequent step, the parameters of each selected map are determined (step 805).

Thereafter, if the resolution of the electronic maps is different from the required display resolution, the selected electronic maps are adapted as a function of their resolution so as to conform with the required display resolution (step 810). If the resolution of the electronic maps is greater than the required display resolution, this step consists in reducing the size of the image representing the map, for example by suppression of points or by weighting. Conversely, if the resolution of the electronic maps is poorer than the required display resolution, this step consists in increasing the size of the image representing the map, for example by interpolation of points on the basis of image points.

The electronic maps are then projected onto a sphere representing approximately the earth, according to the parameters of the electronic maps (step 815). Such a transformation is defined mathematically by the characteristics of the geodesic datum and of the cartographic projection of the electronic maps.

The projection of the maps onto the sphere makes it possible to create one or more spherical cartographic elements (step 820).

Although, according to the foregoing description, all the maps necessary for construction of a background map are processed simultaneously, in parallel manner, it is possible to process these electronic maps in sequential manner, as illustrated by the dashed arrow.

Finally, on the basis of the created cartographic elements, a background map is constructed (step 825) by orthographic azimuthal projection of the spherical cartographic elements onto a plane tangential to the sphere at the reference point according to a projection point located at infinity, as if the sphere were being photographed by a photographic apparatus situated on the normal to the sphere at the reference point, located at infinity.

Advantageously, a priority level is assigned to each electronic map, as described in the foregoing, the projection of the electronic maps onto the sphere being effected according to the inverse order of priorities. Thus the cartographic information items corresponding to the coverage zones are those obtained from the maps having the highest priority levels.

FIG. 9 illustrates an example of implementation of the method described by reference to FIG. 8, according to which the electronic maps are all projected initially onto a sphere 900 representing approximately the earth as a function of the parameters of the maps.

Thus the projection of electronic maps onto sphere 900 makes it possible to obtain spherical cartographic elements 905, 910 and 915 around a reference point 920.

The use of a virtual photographic apparatus 925 placed on normal 930 to sphere 900 at reference point 920, at infinity, makes it possible to take, in real time, a virtual photograph 935 of spherical cartographic elements 905, 910 and 915. Such a virtual photograph represents the orthographic azimuthal projection of spherical cartographic elements 905, 910 and 915 on the plane tangential to sphere 900 at reference point 920 according to a projection point located at infinity.

Virtual photograph 935 comprises a projection 905′ of part of spherical cartographic element 905. Similarly, virtual photograph 935 comprises projections 910′ and 915′ of part of spherical cartographic elements 910 and 915 respectively.

Virtual photograph 935 or a part thereof constitutes the background map displayed on the navigation aid device. As described in the foregoing, it is possible to display geo-referenced data by superposition on the background map.

To limit the processing of electronic maps, it is possible to effect certain preprocessing operations before construction of the background map, for example during the preparation of a flight plan. Such a preprocessing operation may consist in particular in organizing the cartographic elements according to a predetermined standard hierarchical organization, in decompressing the maps if they are compressed, in suppressing coverage zones, in managing priority levels and in assembling certain electronic maps.

Naturally, a person competent in the field of the invention will be able to apply modifications to the foregoing description in order to satisfy specific needs.

1. A method for constructing at least one background map in real time on the basis of a plurality of electronic maps, projection parameters and geodesic parameters being associated with each of the said electronic maps, this method being characterized in that it comprises the following steps,
selection (300, 800) of at least two electronic maps among the said plurality of electronic maps;
conversion (315, 815) of at least part of the said at least two selected electronic maps according to projection parameters and geodesic parameters predetermined as a function of projection parameters and geodesic parameters associated with each of the said at least two selected electronic maps; and
construction (325, 825) of a background map on the basis of the said at least two converted electronic maps.

2. A method according to claim 1, characterized in that it additionally comprises a step of adaptation of resolution (310, 810) of at least part of one of the said at least two selected electronic maps.

3. A method according to any one of the preceding claims, characterized in that the said conversion step comprises a step of orthographic azimuthal projection of at least part of the said at least two selected electronic maps.

4. A method according to any one of the preceding claims, characterized in that each of the said at least two converted electronic maps is represented on a separate graphic layer.

5. A method according to claim 1 or claim 2, characterized in that the said conversion step comprises the following steps,
projection of at least part of the said at least two selected electronic maps onto a sphere according to the projection parameters and the geodesic parameters associated with the said at least two selected electronic maps, referred to as first projection; and
projection, onto a plane, of at least part of the said projection of at least part of the said at least two selected electronic maps onto a sphere, referred to as second projection.

6. A method according to the preceding claim, characterized in that the said second projection is an orthographic azimuthal projection.

7. A method according to any one of the preceding claims, characterized in that a priority level is assigned to each of the said at least two selected electronic maps.

8. A method according to any one of the preceding claims, characterized in that it additionally comprises a step of addition of at least one geo-localized datum.

9. A computer program comprising instructions adapted to the implementation of each of the steps of the method according to any one of the preceding claims.

10. A device comprising means adapted to implementation of each of the steps of the method according to any one of claims 1 to 8.
